(19) United States
(12) Patent Application Publication
(10) Pub. No.: US 2011/0109836 A1
(43) Pub. Date: May 12, 2011

(54) ILLUMINATION DEVICE AND LIQUID CRYSTAL DISPLAY DEVICE

(75) Inventors: Atsuyuki Tanaka, OSAKA (JP); Takeshi Masuda, Osaka-shi (JP); Yuhsaku Ajichi, Osaka-shi (JP)

(73) Assignee: SHARP KABUSHIKI KAISHA, Osaka-shi, Osaka (JP)

(21) Appl. No.: 13/002,535

(22) PCT Filed: Apr. 22, 2009
(86) PCT No.: PCT/JP2009/057997

§ 371 Date: Jan. 4, 2011

(30) Foreign Application Priority Data
Jul. 7, 2008 (JP) 2008-176761

(51) Int. Cl. G02F 1/1335; F21V 8/00

(52) U.S. Cl. 349/61; 362/613

(57) ABSTRACT

A backlight (illumination device) (2) of the present invention includes a plurality of light sources (5) and a plurality of light guides (7, 17, . . . ) that allow light entered into the light guides from the plurality of light sources (5) to be emitted from surfaces of the plurality of light guides (7, 17 . . . ). Each of the light guides (7, 17, . . . ) includes: a light emitting section (7b, 17b, . . . ) that has a light emitting surface (7a); and a light guide section (7c) that guides, to the light emitting section (7b, 17b, . . . ), light entered into the light guides from the plurality of light sources (5). Each of the light guides (7, 17, . . . ) is also arranged such that the light emitting section (17b) of the light guide (17) that is adjacent to the light guide (7) overlaps the light guide section (7c) of the light guide (7). An edge surface (7e) of the light emitting section (17b) of the light guide (17) that overlaps the light guide (7) has concaved and/or convexed shape. The concaved and/or convexed shape serves as a light intensity adjusting section that reduces light transmission quantity.

### TECHNICAL FIELD

The present invention relates to: an illumination device that is used as a backlight or the like of a liquid crystal display device; and the liquid crystal display device that is provided with the illumination device.

### BACKGROUND ART

Recently, a liquid crystal display device has rapidly come into wide use in replacement of a cathode-ray tube display device. The liquid crystal display device has merits such as energy saving, and reduction in thickness and weight thereby having been widely employed for a liquid crystal display television, a monitor, a mobile phone and the like. To further take advantage of the merits, for example, an illumination device (so-called backlight) provided in a backside of the liquid crystal display device has been improved.

The illumination device is mainly divided into a side light type (or an edge light type) and a direct light type. The side-light type illumination device is configured such that a light guide is provided in a backside of a liquid crystal display panel and a light source is provided at a sidelong edge of the light guide. Light emitted from the light source is reflected to the light guide, and the reflected light indirectly yet uniformly illuminates the liquid crystal display panel. This configuration makes it possible to attain an illumination device which is reduced in its thickness and which has excellent luminance uniformity though the illumination device is low in luminance. Therefore, the side-light type illumination device is mainly applied to a small or middle-sized liquid crystal display device such as a mobile phone and a laptop.

Patent Literature 1 discloses, as an example, the side-light type illumination device. Specifically, Patent Literature 1 discloses a surface light emitting device in which a plurality of dots are provided on a reflecting surface of a light guide plate so that light is uniformly emitted from a light emitting surface. The surface light emitting device is configured such that an edge part of the reflecting surface is provided with more dots than those provided in other part of the reflecting surface because otherwise the edge part of the reflecting surface is out of reach of light from a light source and becomes dark due to directivity of the light source.

The direct-light type illumination device is configured such that a plurality of light sources are arranged in a backside of a liquid crystal display panel and the plurality of light sources directly illuminate the liquid crystal display panel. This allows even a large screen to have great luminance. The direct-light type illumination device is applied mainly to a large liquid crystal display device having a size of 20 inches or greater. However, the direct-light type illumination device has a thickness ranging no less than substantially from 20 mm to 40 mm. This prevents the display device from being further reduced in thickness.

Further reduction in thickness of the large liquid crystal display device can be attained by decrease in a distance between the light source and the liquid crystal display panel. However, in this case, the light source needs to be increased in its number in order to attain luminance uniformity of the illumination device. The increase in its number of the light source causes high cost. Accordingly, the following illumination device has been required to be developed: an illumination device which is reduced in thickness and which has excellent luminance uniformity with no increase in its number of the light source.

Conventionally, to solve the above-described problem, the large liquid crystal display has been reduced in its thickness by arranging a plurality of side-light type illumination devices.

For example, Patent Literature 2 discloses a surface light source device which is suitably applicable to the large liquid crystal display because the surface light source device can retain a wide light emitting region in despite of a compact configuration of the surface light source device. The surface light source device has a tandem structure in which plate-like light guide blocks are arranged in tandem and primary light sources that emit primary light to the light guide blocks respectively are provided.

The illumination device in which a plurality of light emitting units each configured by using the light source and the light guide in combination are arranged as described above is called a tandem illumination device.

### CITATION LIST

### Patent Literature

### Patent Literature 1

Japanese Patent Application Publication Tokukai No. 2003-43266 A (Publication Date: Feb. 13, 2003)

### Patent Literature 2

Japanese Patent Application Publication Tokukaihei No. 11-288611 A (Publication Date: Oct. 19, 1999)

### Patent Literature 3

Japanese Patent Application Publication Tokukai No. 2001-312916 A (Publication Date: Nov. 9, 2001)

### SUMMARY OF INVENTION

However, the illumination device in which the light guide and the light source are used in combination causes the following problem. A plurality of light guides are arranged in a plane. In this case, a bright line occurs in a region that corresponds to a joint part of the light guide. This causes luminance unevenness thereby still resulting in nonuniform luminance.

The following describes a principle that causes the bright line. FIG. 11 is a cross-sectional view schematically showing a configuration of a light guide that configures a tandem backlight. FIGS. 13 and 14 each are a view schematically showing a light traveling direction in which light travels in the light guide.

As shown in FIG. 11, one light guide (left-hand side of FIG. 11) overlaps the other light guide (right-hand side of FIG. 11) adjacent to the one light guide with no space between them. As shown in FIG. 13, most of light emitted from the light source travels in the light guide via repeating total reflection, and then is emitted outward from a light emitting surface. However, as shown in FIG. 14, a part of the light emitted from the light source undergoes no total reflection and directly reaches an edge surface (7e) that is distal to where the light source is provided. Such light is not reduced in its light intensity due to the lack of the total reflection thereby causing such light to have great intensity. As a result, the light emitted from the edge surface (7e) forms a bright line.

Meanwhile, according to the arrangement of FIG. 11, the light emitted from the edge surface (7e) that is distal to the light source of the other light guide (the light guide on right-hand side of FIG. 11) enters the one light guide (the light guide on the left-hand side of FIG. 11) and travels in the one light guide (in a direction of a wide arrow shown in FIG. 11). The light repeats total reflection in the one light guide and then is emitted from the light emitting surface of the one light guide. As described above, according to the arrangement of FIG. 11, a plurality of light guides are arranged with no space between them. This forms the light emitting surfaces of the plurality of light guides with no space between the light emitting surfaces thereby causing no bright line. It is therefore possible to attain uniform luminance.

In practice, however, a light guide that is actually used is generally manufactured with minus tolerance in consideration of various factors such as collision damage of the light guides, reduction in thickness of the illumination device, and production tolerances, and the like. Therefore, as shown in FIG. 12, a space as permitted by the minus tolerance would be formed at the joint part between the one light guide and the other light guide. Due to the space, the light emitted from the edge surface (7e) that is distal to the light source of the other light guide is divided into light that enters the one light guide and light (wide arrow shown in FIG. 12) that escapes upward from the other light guide without entering the one light guide. As described above, such light emitted from the edge surface (7e) that is not the light emitting surface has greater light intensity than that of the light emitted from the light emitting surface. This causes such light to have great luminance. As a result, the light that escapes upward from the edge surface (7e) appears as a bright line.

Such bright line occurs not only in the tandem backlight but also in a backlight in which a plurality of light guides shown in FIG. 21 are arranged in a single plane without overlapping one another (such a backlight is called a tiling backlight).

To solve the problem of the bright line, for example, Patent Literature 3 discloses an arrangement in which dot patterns that diffuse light emitted from the light guide plate are arranged over a whole surface between the light guide and a diffusion plate. According to this arrangement, it is possible to diffuse light that appears as a bright line. This alleviates luminance nonuniformity.

As described above, this arrangement makes it possible to alleviate the luminance unevenness due to the bright line. However, dots of the dot patterns also cause another luminance unevenness. The dot patterns diffuse light to uniform the luminance. However, it is difficult to completely uniform the luminance by using the dot patterns. Therefore, the luminance unevenness is influenced by dots of the dot patterns arranged with different arrangement densities according to how far from the light source the dots are located.

Patent Literature 3 also discloses an arrangement in which a light shielding layer is provided on the edge surface from which light that causes bright lines is emitted. According to this arrangement, it is possible to shield the bright light emitted from the edge surface. It is therefore possible to suppress appearance of a bright line. However, according to this arrangement, light is not emitted from the edge surface. This causes a region corresponding to the edge surface from which light is not emitted to appear as a dark line. It is therefore still difficult to attain uniform luminance.

A display device that employs such an illumination device as a backlight causes deterioration in a display quality.

The present invention was made in view of the problem, and an object of the present invention is to provide an illumination device that can further improve luminance uniformity, the illumination device including a plurality of light guides.

An illumination device of the present invention, to attain the object, includes a plurality of light sources; a plurality of light guides, each of which allows light that enters into the light guide from corresponding one or ones of the light sources to be emitted from a surface of the light guide; and a light intensity adjusting section for reducing light transmission quantity, the light intensity adjusting section being provided between each of the light guides aligned along an optical axis direction of light emitted from the light sources, the light intensity adjusting section being provided on at least one of face-to-face edge surfaces of the light guides adjacent each other and having a concaved and/or convexed shape.

According to the illumination device in which the plurality of light guides and the plurality of light sources are used in combination as described above, the light emitted from the edge surface present between the light guides adjacent to each other along the optical axis direction of the light emitted from the light source is not reduced in its light intensity due to the lack of total reflection. Such light has greater light intensity than that of the light emitted from the light emitting surface. This causes such light to have great luminance. As a result, the light emitted from the edge surface appears as a bright line thereby causing luminance unevenness.

Meanwhile, according to the arrangement of the present invention, the light intensity adjusting section that reduces light transmission quantity is arranged between the light guides adjacent each other along the optical axis direction of the light emitted from the light source. The optical axis direction of the light emitted from the light source means a direction (directivity direction) of a main component of the directional light emitted from the light source. Further, the optical axis direction of the light emitted from the light source is, in other words, a direction (light guide direction) in which the light which is emitted from the light source and which then enters the light guide is mainly guided.

This makes it possible to reduce the light quantity of light emitted from the edge surface. As a result, the light emitted from the edge surface in this configuration can be lower in luminance than the light directly emitted outward from the edge surface. It is therefore possible to alleviate appearance of bright lines. Further, a conventional arrangement blocks off the light emitted from the edge surface. Meanwhile, the arrangement of the present invention can reduce the light quantity of the light emitted outward from the edge surface. This makes it possible to prevent appearance of dark lines that have conventionally occurred. It is therefore possible to further improve luminance uniformity of the illumination device.

Further, according to the arrangement of the present invention, the light intensity adjusting section is attained by processing the edge surface of the light guide to have the concaved and/or convexed shape. It is therefore unnecessary to separately manufacture the light intensity adjusting section and the light guide and to attach the light intensity adjusting section to the edge surface of the light guide. This makes it possible to reduce the number of components in assembly and to lower manufacturing cost.

As a result, according to the arrangement of the present invention, the illumination device with a simpler arrangement can attain better luminance uniformity than the conventional illumination devices.

The illumination device of the present invention may be arranged such that the concaved and/or convexed shape is formed by a plurality of convexities, which are arranged in parallel and each of which has two faces that forms a right-angled crest therebetween.

According to the arrangement, the convexities serving as reflection prisms can reflect the light that reaches the edge surface of the light guide from the light source. This causes the light quantity of light emitted from the edge surface of the light guide to be substantially half.

The convexities may be arranged along a thickness direction of the light guide (that is, a direction perpendicular to the light emitting surface of the light guide). The convexities may also be arranged along a direction orthogonal to the thickness direction of the light guide. Preferably, the concaved and/or convexed shape is formed by the plurality of convexities arranged in parallel with a light emitting surface of the at least one of the light guides adjacent each other.

The illumination device of the present invention may be arranged such that the concaved and/or convexed shape is formed by a plurality of quadrangle pyramid convexities arranged longitudinally and latitudinally.

According to the arrangement, the convexities serving as reflection prisms can reflect the light that reaches the edge surface of the light guide from the light source. This causes the light quantity of light emitted from the edge surface of the light guide to be substantially half.

The illumination device of the present invention may be arranged such that each of the light guides includes a light emitting section that has the light emitting surface and a light guide section that guides, to the light emitting section, the light entered into the light guide from the at least one of the plurality of light sources, each of the light guides overlaps with its adjacent one in such a manner that the light emitting section of the light guide overlaps the light guide section of the adjacent one, the light intensity adjusting section is provided on the at least one of the face-to-face edge surfaces which is an edge surface of a light emitting section of that one of the light guides adjacent each other which is on the other one of the light guides.

According to the arrangement, it is possible to attain the tandem illumination device. Further, the concavo-convex light intensity adjusting section is provided on the edge surface (that is, edge surface distal to the light source) of the light emitting section of the one light guide that overlaps the another light guide. This makes it possible to alleviate appearance of bright lines thereby improving luminance uniformity, with a simpler arrangement.

The illumination device of the present invention may be arranged such that the light guides are arranged so as not to overlap one another, each of the light guides is associated with at least a pair of light sources among the light sources, the pair of light sources are arranged so as to face each other, and the respective face-to-face edge surfaces of the light guides adjacent each other have the concaved and/or convexed shape.

According to the arrangement, the pair of light sources that are arranged so as to face each other illuminate regions with light such that one of the pair of light sources illuminates one of the regions which cannot be illuminated by the other of the pair of light sources and that the other of the pair of light sources illuminates the other of the regions which cannot be illuminated by the one of the pair of light sources. This makes it possible to attain the tiling illumination device that causes no dark line. Further, the concaved and/or convexed shape serving as the light intensity adjusting section is formed on the respective edge surfaces of the light guides adjacent each other. This makes it possible to alleviate appearance of bright lines thereby improving luminance uniformity, with a simpler arrangement.

A liquid crystal display device of the present invention, including, as a backlight, an illumination device having any one of the arrangements of the present invention.

According to the arrangement, the liquid crystal display device of the present invention includes the illumination device of the present invention. This makes it possible to attain the liquid crystal display device that has excellent luminance uniformity.

For a fuller understanding of the nature and advantages of the invention, reference should be made to the ensuing detailed description taken in conjunction with the accompanying drawings.

### BRIEF DESCRIPTION OF DRAWINGS

FIG. 1 is a cross-sectional view schematically showing a configuration of a liquid crystal display device in accordance with First Embodiment of the present invention.

FIG. 2 is a perspective view schematically showing a configuration of a backlight provided in the liquid crystal display device shown in FIG. 1.

FIG. 3 is a perspective view schematically showing a configuration of a light guide unit provided in the backlight shown in FIG. 2.

FIG. 4 is an enlarged cross-sectional view of a part of the backlight shown in FIG. 2.

FIG. 5 is a cross-sectional view of concaved and/or convexed shape formed on an edge surface of a light guide.

FIG. 6 is a perspective view of concaved and/or convexed shape formed on an edge surface of a light guide.

FIG. 7 is a perspective view of another concaved and/or convexed shape formed on an edge surface of a light guide.

FIG. 8 is a perspective view of yet another concaved and/or convexed shape formed on an edge surface of a light guide.

FIG. 9 is a view showing an example of dimensions of parts of a light guide unit.

FIG. 10 is a table showing a measurement result of quantity of light that leaks from an edge surface of the light guide unit shown in FIG. 9.

FIG. 11 is a cross-sectional view schematically showing a configuration of a light guide that configures a conventional tandem backlight in which two light guide units adjacent each other are arranged with no space between them.

FIG. 12 is a cross-sectional view schematically showing a configuration of a conventional light guide that configures a tandem backlight that is actually used.

FIG. 13 is a view schematically showing a traveling direction in which light travels in a light guide.

FIG. 14 is a view schematically showing a traveling direction in which light travels in a light guide.

FIG. 15 is a cross-sectional view schematically showing a configuration of a liquid crystal display device in accordance with Second Embodiment of the present invention.

FIG. 16 is an enlarged cross-sectional view of a part of the liquid crystal display device shown in FIG. 15.

FIG. 17 is a plan view schematically showing a configuration of a backlight provided in the liquid crystal display device shown in FIG. 15.

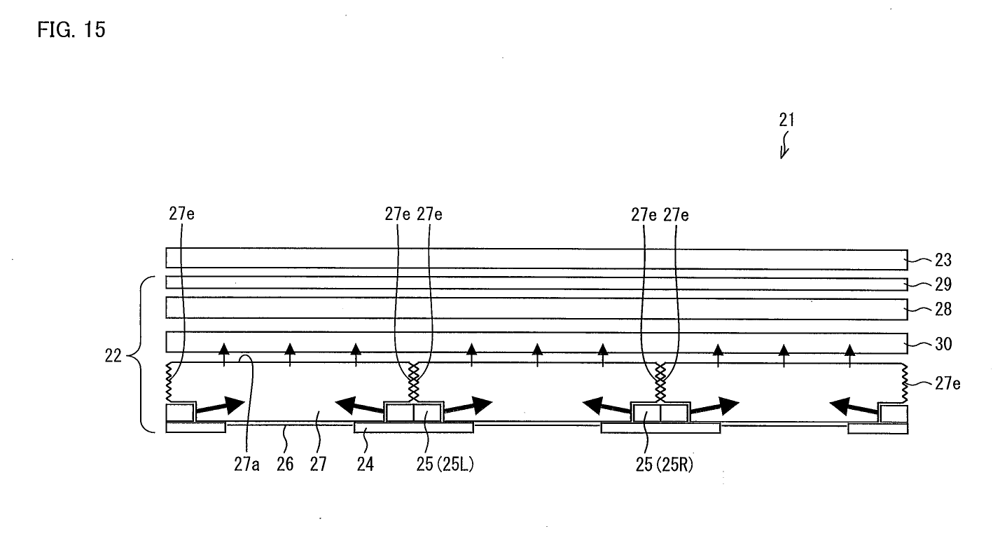

(a) of FIG. 18 is a plan view in a case where a light guide unit provided in the liquid crystal display device shown in FIG. 15 is viewed from a liquid crystal display panel. (b) of FIG. 18 is a plan view in a case where the light guide unit provided in the liquid crystal display device shown in FIG. 15 is viewed from a backlight. (c) of FIG. 18 is a cross-sectional view taken along A-A line of the light guide unit shown in (a) of FIG. 18.

(a) of FIG. 19 is a view schematically showing a traveling direction of light emitted from a light source provided in one side (left-hand side) of a light guide unit. (b) of FIG. 19 is a view schematically showing a traveling direction of light emitted from a light source provided in the other side (right-hand side) of the light guide unit.

FIG. 20 is a cross-sectional view schematically showing a configuration of a conventional tiling backlight in which two light guide units adjacent each other are arranged with no space between them.

FIG. 21 is a cross-sectional view schematically showing a configuration of a conventional tiling backlight that is actually used.

### DESCRIPTION OF EMBODIMENTS

### First Embodiment

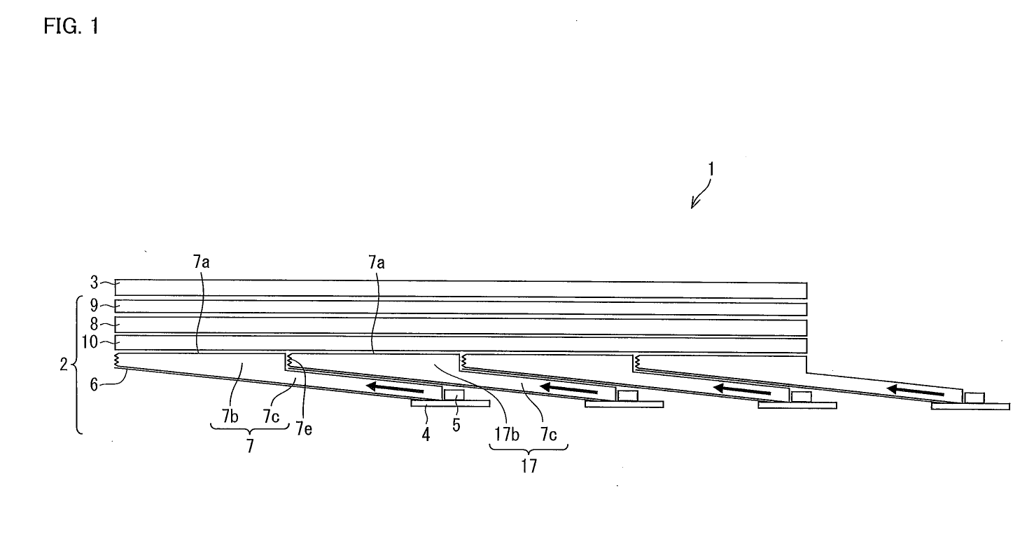

The following describes First Embodiment of the present invention with reference to FIGS. 1 through 10. Note that the present invention is not limited to First Embodiment.

In the present embodiment, an illumination device that is used as a backlight of a liquid crystal display device is described.

FIG. 1 is a cross-sectional view schematically showing a configuration of a liquid crystal display device 1 of the present embodiment. The liquid crystal display device 1 includes a backlight 2 (illumination device) and a liquid crystal display panel 3 that is arranged so as to face the backlight 2.

The liquid crystal display panel 3 is the same as a liquid crystal display panel that is generally provided in a conventional liquid crystal display device. The liquid crystal display panel 3 includes, for example, an active matrix substrate (not shown) and a CF substrate (not shown) provided so as to face the active matrix substrate. On the active matrix substrate, a plurality of TFTs (thin film transistors) are provided. The liquid crystal display panel 3 also includes a liquid crystal layer (not shown) sealed by a seal material, between the active matrix substrate and the CF substrate.

The following describes in detail a configuration of the backlight 2 provided in the liquid crystal display device 1.

The backlight 2 is arranged in a backside of the liquid crystal display panel 3 (on a surface opposite to a display surface of the liquid crystal display panel 3). As shown in FIG. 1, the backlight 2 includes a substrate 4, a light source 5, a reflecting sheet 6, a light guide 7, a diffuser 8, an optical sheet 9 and a transparent plate 10. The backlight 2 includes at least two light guides. In the present embodiment, for convenience of description, one of the at least two light guides is described as a light guide 7, and the other of the at least two light guides is described as a light guide 17. Further, the light guide 7 is described as an example on behalf of the light guides 7 and 17 unless otherwise particularly stated to describe the light guide 17.

The light source 5 is, for example, a light emitting diode (LED) that employs side light emitting, or a cold cathode fluorescent tube (CCFL). The following describes the LED as an example of the light source 5. In the present embodiment, the LED employing side light emitting in which R, G and B chips are molded into one package is used as the light source 5. This makes it possible to attain an illumination device having a broad color reproduction scope. The light source 5 is arranged on the substrate 4.

The light guide 7 allows light emitted from the light source 5 to be emitted from a light emitting surface 7a. The light emitting surface 7a is a surface from which light illuminates an object to be illuminated. As shown in FIG. 1, the light guide 7 of the present embodiment has a tandem structure. That is, the light guide 7 includes a light emitting section 7b that has the light emitting surface 7a and a light guide section 7c that guides, to the light emitting section 7b, the light emitted from the light source 5. The light emitting section 7b has a different thickness from that of the light guide section 7c at least at a joint part where the light emitting section 7b is connected to the light guide section 7c. A light emitting section 17b of the light guide 17 overlaps the light emitting section 7c of the light guide 7. This forms a flush light-emitting surface (a whole light emitting surface of the backlight 2; a light emitting region) by arranging a plurality of light guides 7, 17 . . . . A reference sign 7e indicates an edge surface that is distal to the light source 5.

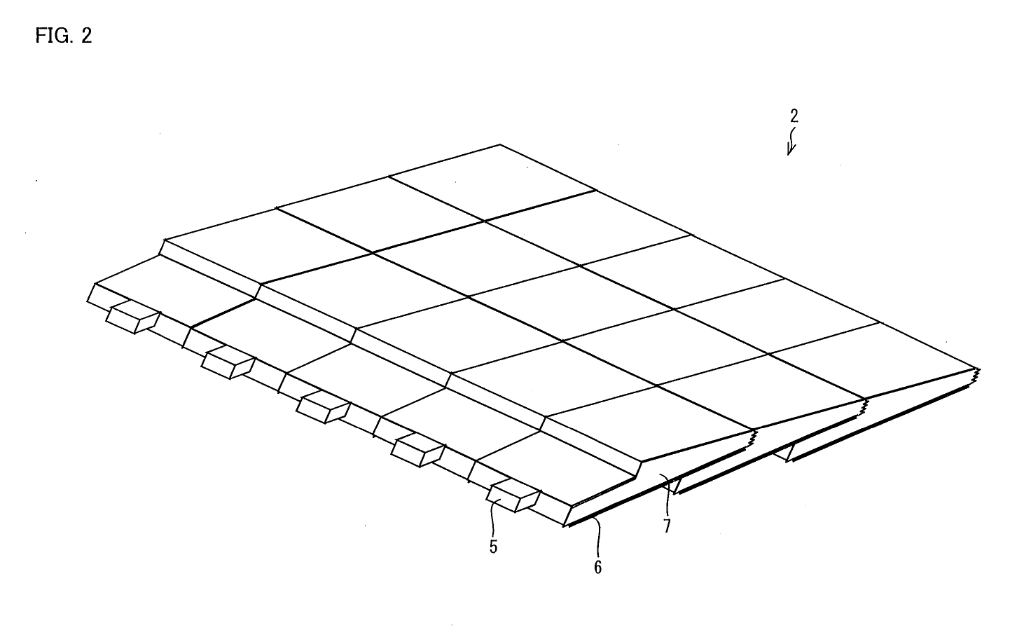

FIG. 2 is a perspective view showing a configuration of the backlight 2 provided in the liquid crystal display device 1 shown in FIG. 1. As shown in FIG. 2, the backlight 2 is configured such that light guide units 12 in each of which the light source 5 and the light guide 7 that allows the light emitted from the light source 5 to be emitted from a surface of the light guide 7 are used in combination are arranged longitudinally and latitudinally.

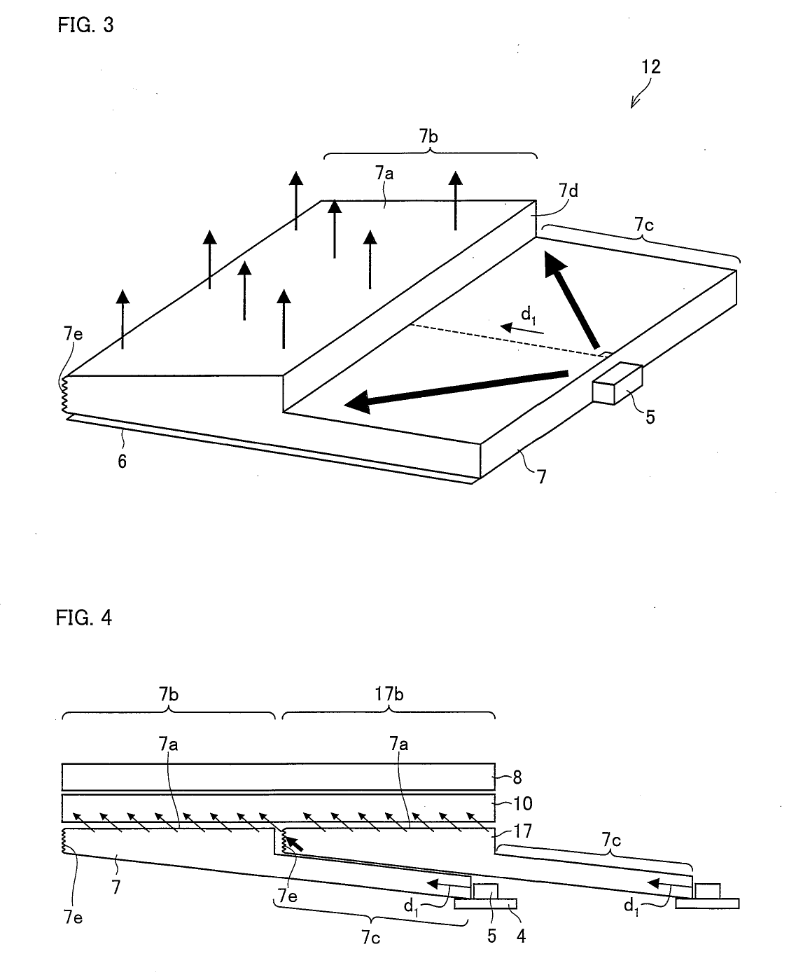

FIG. 3 is a perspective view schematically showing a configuration of the light guide unit 12 provided in the backlight 2 shown in FIG. 2. The light guide unit 12 diffuses the light emitted from the light source 5 to allow the diffused light to be emitted from the surface of the light guide 7. The light guide unit 12 includes the light source 5, the substrate 4 (see FIG. 1), the reflecting sheet 6 and the light guide 7. As shown in FIG. 3, the light emitted from the light source 5 enters the light guide section 7c of the light guide 7, travels in the light guide section 7c and reaches the light emitting section 7b. One surface (light emitting surface 7a) of the light emitting section 7b of the light guide 7, or the other surface of the light emitting section 7b opposite to the light emitting surface 7a is processed so that the light that enters the light emitting section 7b is emitted from the light emitting surface 7a though the processing is not shown in FIG. 3. The light that enters the light emitting section 7b is emitted from the light emitting surface 7a of the light guide 7 toward the liquid crystal display panel 3. Examples of the concrete processing carried out with respect to the light emitting section 7b of the light guide 7 encompass prism processing, grain finish and print processing. However, the processing method of the present embodiment is not particularly limited. Conventional processing methods may be adopted as appropriate.

The light guide 7 is made from transparent resin such as polycarbonate (PC), polymethyl methacrylate (PMMA) or like material. However, the material is not particularly limited as long as the material has excellent light transmission. Further, the light guide 7 can be formed by, for example, injection molding, extrusion molding, heat press molding or cutting. However, the forming method is not limited to these forming methods, and any processing methods may be adopted as long as the processing methods bring properties identical to those brought by the above-described processing methods.

The reflecting sheet 6 is provided so as to be in contact with a backside (a surface opposite to the light emitting surface 7a) of the light guide 7. The reflecting sheet 6 reflects light so that as much as possible of light is emitted from the light emitting surface 7a. In the present embodiment, a plurality of light guides 7 are provided.

Therefore, the reflecting sheet 6 is provided on each of the plurality of light guides 7, 17 . . . .

The diffuser 8 is provided so as to face the light emitting surface 7a in such a manner that the diffuser 8 covers a flush light-emitting surface (light emitting region) made up of the light emitting surfaces 7a of the light guides 7, 17 . . . . The diffuser 8 diffuses the light emitted from the light emitting surface 7a of the light guide 7 to allow the diffused light to illuminate the optical sheet 9. In the present embodiment, a “SUMIPEX E RMA10” having a thickness of 2.0 mm, manufactured by Sumitomo Chemical Co., Ltd. is used as the diffuser 8.

The optical sheet 9 is made up of a plurality of sheets that are piled up above the light guide 7. The optical sheet 9 uniforms and collects the light emitted from the light emitting surface 7a of the light guide 7, and the uniformed and collected light then illuminates the liquid crystal display panel 3. That is, the following sheets are applicable to the optical sheet 9: a diffusion sheet that collects and diffuses light; a lens sheet that collects light to improve luminance of a front direction (a direction of the liquid crystal display panel); and a polarization reflecting sheet which reflects one polarization component of light and which transmits the other polarization component of the light so as to improve luminance of the liquid crystal display device 1. It is preferable to use these sheets in combination as appropriate according to price and performance of the liquid crystal display device 1. In the present embodiment, a “LIGHT-UP 250 GM2” manufactured by KIMOTO Co., Ltd. is used as the diffusion sheet, a “Thick RBEF” manufactured by Sumitomo 3M Co., Ltd. is used as a prism sheet, and a “DBEF-D400” manufactured by Sumitomo 3M Co., Ltd. is used as the polarization sheet.

The transparent plate 10 is used for retaining a constant distance between the light guide 7 and the diffuser 8, and forms a light diffusion region. The transparent plate 10 is made from light-transmitting material such as polyethylene film or like material. Note that the light guide 7 and the diffuser 8 may be provided so as to be in contact with each other without providing the transparent plate 10 between the light guide 7 and the diffuser 8.

According to the arrangement of the above-described members, as shown in FIGS. 3 and 13, the light emitted from the light source 5 travels in the light guide 7 while continuously diffusing and reflecting. Then, the light is emitted from the light emitting surface 7a and reaches the liquid crystal display panel 3 through the diffuser 8 and the optical sheet 9.

(Luminance Uniformity)

The following describes a principle of luminance nonuniformity.

As shown in FIG. 13, the light that enters, at a critical angle, the light guide section 7c of the light guide 7 from the light source 5 reaches the light emitting section 7b via repeating total reflection in the light guide section 7c, is reflected on the reflecting sheet 6 that is provided in a backside of the light emitting section 7b, and is emitted from the light emitting surface 7a. Because a majority of the light emitted from the light source 5 repeats the total reflection in the light guide 7 as described above, the light emitted from the light source 5 is gradually lowered in light intensity as the light travels farther away from the light source 5.

However, as shown in FIG. 14, a part of the light emitted from the light source 5 undergoes no total reflection and directly reaches the edge surface 7e that is distal to the light source 5. Such a part of light is not reduced in its light intensity due to the lack of total reflection thereby causing such a part of light to have greater intensity than that of the light emitted from the light emitting surface 7a.

Further, as shown in FIG. 12, the light guide having the tandem structure is configured such that the light emitting section of the one light guide and the light emitting section of the other light guide that is adjacent to the one light guide have a space therebetween. Through the space, the light emitted from the light source is directly emitted outward from the edge surface 7e of the other light guide. Such emitted light having great intensity forms bright lines. This causes luminance unevenness as a whole.

To solve the problem, for example, a light intensity adjusting section that reduces light transmission quantity may be provided in a region where bright lines occur. The light intensity adjusting section reduces the light quantity of light that illuminates the light intensity adjusting section, and exits the reduced light outward. To attain the light intensity adjusting section, for example, a semi-transparent material may be attached to the region of the light guide in which region a bright line would occur. However, according to the above-described method, it is necessary to additionally manufacture the light intensity adjusting section that is another member other than the light guide and to provide the light intensity adjusting section in a proper region of the light guide. This causes increase in manufacturing cost. Further, it is also necessary to accurately position the light intensity adjusting section on the light guide in order to improve luminance nonuniformity.

To reduce the light quantity of light emitted from the edge surface 7e of the light guide which light causes bright lines, the edge surface 7e of the present embodiment has concaved and/or convexed shape. This concaved and/or convexed shape serves as the light intensity adjusting section.

(Concaved and/or Convexed Shape)

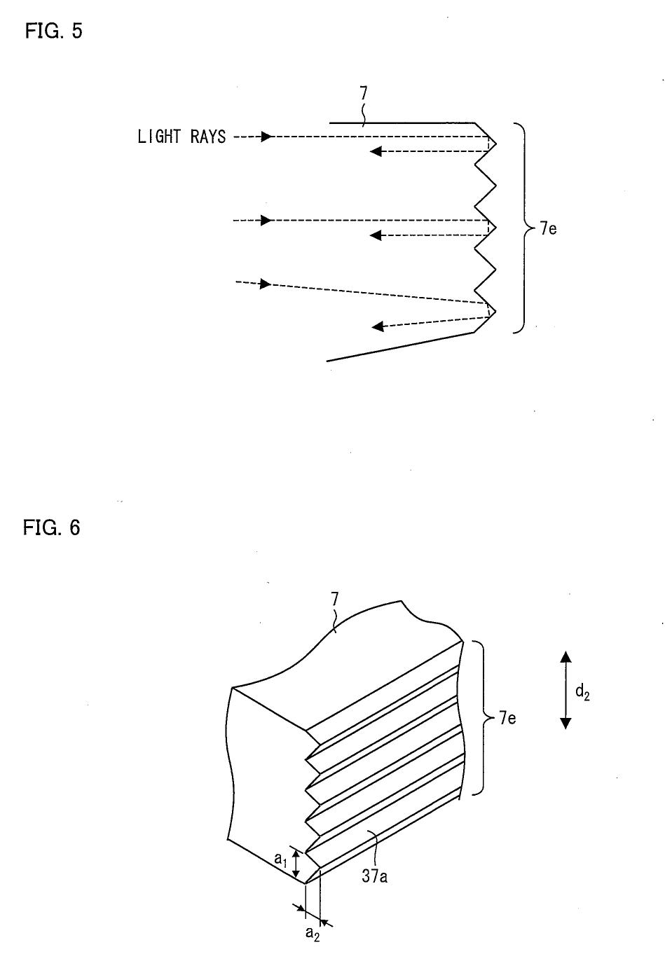

FIG. 4 is an enlarged cross-sectional view of a part of the backlight 2 shown in FIG. 2.

As shown in FIG. 4, the concaved and/or convexed shape serving as the light intensity adjusting section is provided between the light guide 7 and the light guide 17 that are adjacent each other along an optical axis direction d1 of the light emitted from the light source 5. The optical axis direction of the emitted light is, in other words, a directivity direction of the emitted light or a light guide direction of the light that enters the light guide. Specifically, the concaved and/or convexed shape is formed on the edge surface 7e which is distal to the light source 5 of the light guide 17 that is arranged so as to overlap the light guide section 7c of the light guide 7, the edge surface 7e being different from the light emitting surface 7a of the light guide 17.

FIG. 5 shows paths of light rays which reach and reflect on the edge surface 7e of the light guide 7 on which edge surface 7e the concaved and/or convexed shape is formed. FIG. 6 is an enlarged view of the concaved and/or convexed shape that is formed on the edge surface 7e. As shown in FIG. 6, the concaved and/or convexed shape formed on the edge surface 7e is formed such that a plurality of convexities 37a (convexities 37a each made up of two plain faces that forms a right angle therebetween) each made up of two faces that forms a right-angled crest are arranged along a thickness direction d2 (see FIG. 6) of the light guide 7. The thickness direction d2 of the light guide 7 is a direction perpendicular to the light emitting surface 7a of the light guide 7. That is, the concaved and/or convexed shape shown in FIG. 6 is formed such that the plurality of convexities 37a are arranged so as to be parallel to the light emitting surface 7a. In other words, the concaved and/or convexed shape is formed such that a plurality of triangular prisms having the same size as one another are arranged.

As shown in FIG. 5, most of the light that reaches the edge surface 7e having the concaved and/or convexed shape from the light source is reflected by the prisms. That is, the concaved and/or convexed shape formed on the edge surface 7e of the light guide 7 allows most of the light that reaches the edge surface 7e to be reflected back to inside of the light guide. More specifically, in a case where a light guide having a refractive index n of 1.5 is employed and a direction perpendicular to the prism surfaces on which the concaved and/or convexed shape is formed is 0°, light that enters by an angle ranging from −42° to +42° is emitted from the prism surfaces, on the other hand, two kinds of light that enters by an angle ranging from 42° to 90° and light that enters by an angle ranging from −42° to −90° are reflected on the prism surfaces.

It is therefore possible to reduce the light quantity of light which directly reaches the edge surface 7e from the light source 5 and which is then emitted from the edge surface 7e. This makes it possible to reduce luminance of the light emitted from the edge surface 7e. It is accordingly possible to prevent appearance of bright lines. As such, the arrangement of the present embodiment can further improve luminance uniformity, compared to a conventional arrangement.

The light guide 7 having the above-described concaved and/or convexed shape can be manufactured by injection molding by use of a mold for molding the light guide on which mold prisms are carved. As described above, in the present embodiment, it is possible to form the light intensity adjusting section in synchronization with manufacturing the light guide 7. This can reduce the number of components in assembly and also can manufacture the components at low cost.

Further, the concaved and/or convexed shape formed on the edge surface 7e of the light guide 7 allows reduction in intensity of the light emitted from the edge surface 7e. It is therefore unnecessary to provide, in a region between the light emitting surface 7a and the diffuser 8, the light intensity adjusting section for uniforming the light intensity. This also yields an effect of reducing the backlight 2 in its thickness.

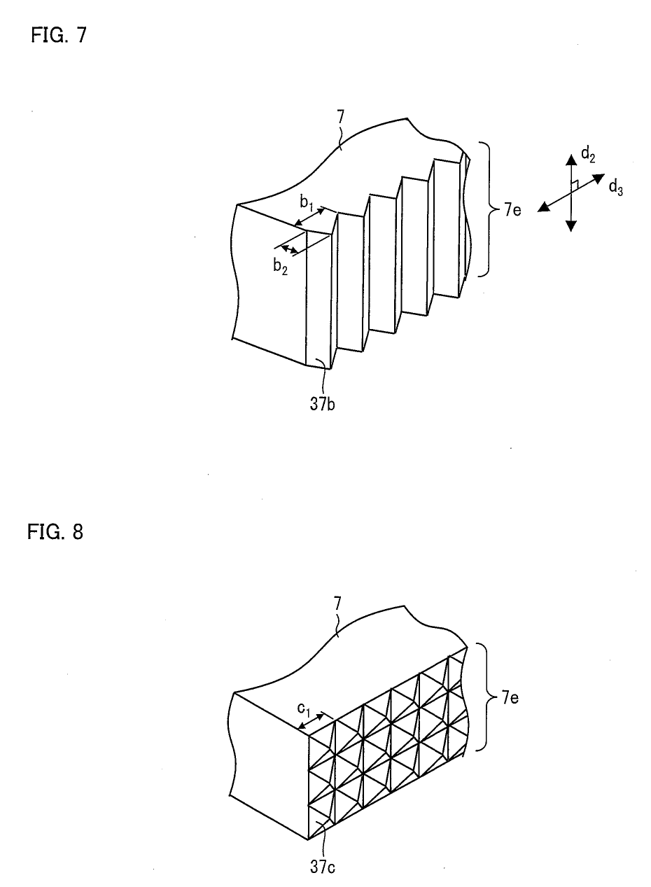

The concaved and/or convexed shape formed on the edge surface 7e of the light guide 7 is not limited to the concaved and/or convexed shape shown in FIG. 6. FIGS. 7 and 8 each show another example of the concaved and/or convexed shape of the present embodiment.

The concaved and/or convexed shape formed on the edge surface 7e of the light guide 7 shown in FIG. 7 is formed such that triangular prism-shaped convexities 37b that are identical to the convexities 37a shown in FIG. 6 are arranged along a direction d3 perpendicular to the thickness direction d2 of the light guide 7. That is, the concaved and/or convexed shape shown in FIG. 7 is formed such that the plurality of convexities 37b are arranged perpendicularly to the light emitting surface 7a of the light guide 7. Further, the concaved and/or convexed shape formed on the edge surface 7e of the light guide 7 shown in FIG. 8 is formed such that a plurality of quadrangular pyramid convexities 37c are arranged longitudinally and latitudinally (in a longitudinal direction and in a lateral direction). The longitudinal direction is the thickness direction d2 of the light guide 7, and the lateral direction is the direction d3 perpendicular to the thickness direction d2 (see FIG. 7). Quadrangles each having four faces that configures each of the quadrangle pyramid convexities 37c are right triangles having the same size as one another.

(Measurement of Quantity of Light that Leaks from Edge Surface 7e of Light Guide 7)

The following shows a measurement result of quantity of light that leaks from the edge surface 7e of the light guide 7 on which the edge surface 7e the concaved and/or convexed shape shown in FIGS. 6 through 8 is formed.

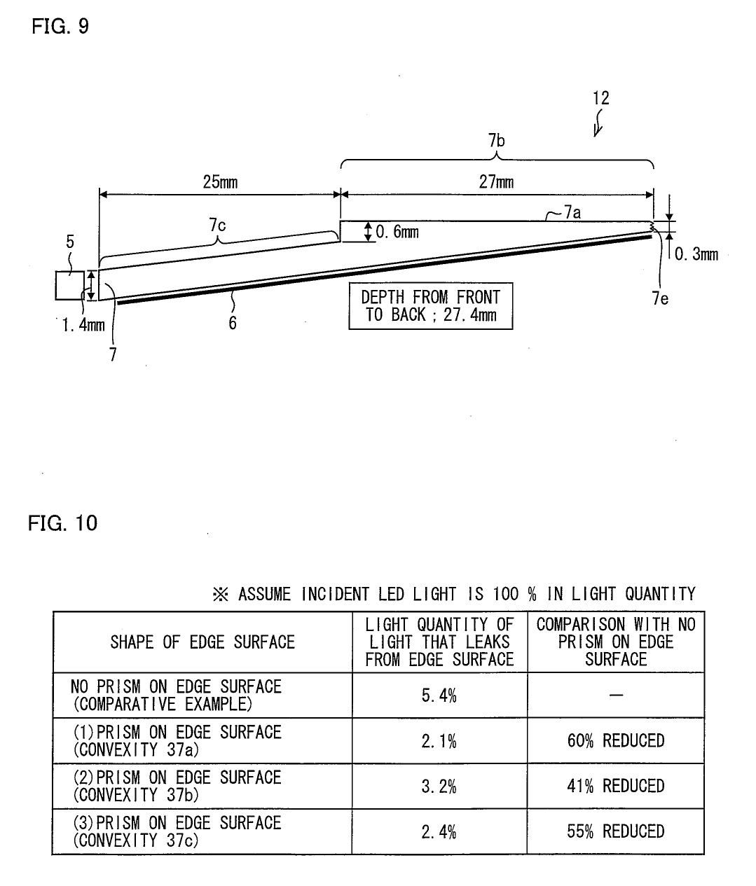

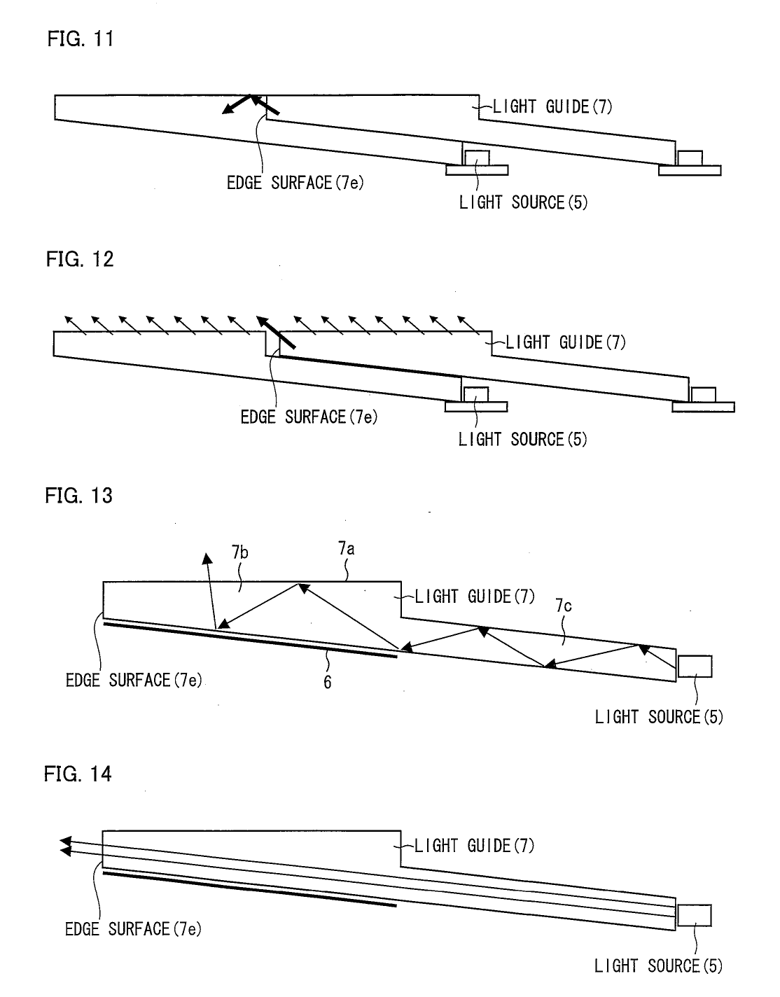

FIG. 9 shows dimensions of parts of the light guide unit 12 used in measurement. Further, a dimension of the concaved and/or convexed shape shown in FIG. 6 is described as follows: a pitch a1 of the convexity 37a is 30 μm; and a height a2 of the convexity 37a is 15 μm. Furthermore, the dimension of the concaved and/or convexed shape shown in FIG. 7 is described as follows: a pitch b1 of the convexity 37b is 30 μm; and a height b2 of the convexity 37b is 15 μm. Moreover, the dimension of the concaved and/or convexed shape shown in FIG. 8 is described as follows: a pitch c1 of the convexity 37c is 100 μm; and a height c2 (not shown) of the convexity 37 is 50 μm.

FIG. 10 shows the measurement result of the quantity of the light that leaked from the edge surface 7e of the light guide 7. FIG. 10 also shows, as a comparative example, a measurement result of light leakage quantity in a case where the concaved and/or convexed shape was not formed on the edged surface 7e. “The quantity of the light that leaked from the edge surface” shown in FIG. 10 is the quantity of the light that leaked from the edge surface 7e, the quantity being indicated by percentage in a case where the light quantity of light that entered the light guide 7 from the light source 5 (LED) was 100%.

FIG. 10 shows that the light leakage quantity was reduced by on the order of percentage ranging from 40% to 60% in the case where the concaved and/or convexed shape was formed on the edge surface 7e compared to the comparative example in which no concaved and/or convexed shape was formed on the edge surface 7e. The concaved and/or convexed shape shown in FIG. 6 has the most excellent effect of reducing the light intensity among the concaved and/or convexed shape shown in FIGS. 6 through 8.

As described above, according to the backlight 2 of the present embodiment, it is possible to reduce the quantity of the light that leaks from the edge surface 7e of the light guide 7 thereby preventing appearance of bright lines. This makes it possible to improve luminance uniformity.

A backlight shown in, for example, FIGS. 14 through 16 of Patent Literature 3 is configured such that a single light guide is used for the whole screen. According to such a backlight with this configuration, it is difficult to clearly distinguish regions from regions and therefore difficult for each of the regions to have its own peak luminance in a case where light emitting luminance of a region of the backlight which region corresponds to a region of a liquid crystal display panel is modified in accordance with display luminance of the region of the liquid crystal display panel, that is, in a case where an area active drive is carried out.

Meanwhile, according to the arrangement of the present embodiment, the light emitting sections of the light guides are clearly distinguished one another. It is therefore possible for the light guides each to have its own peak luminance in the case where the area active drive is carried out. Further, according to the arrangement of the present embodiment, the concaved and/or convexed shape formed on the edge surface between the light guides adjacent each other allows the light guides each to have its own peak luminance more easily. It is therefore possible to adjust luminance of each region in more accurate response to an instruction from a drive section. A conventionally well-known method can be applied to a method of the area active drive.

Further, the illumination device of the present invention has excellent luminance uniformity even in a case where a light emitting area increases. It is therefore preferable to apply the illumination device of the present invention particularly to a backlight of a liquid crystal display device including a large screen. However, the illumination device of the present invention is not limited to this, and can be applied to backlights of various liquid crystal display devices.

### Second Embodiment

The following describes Second Embodiment of the present invention with reference to FIGS. 15 through 19.

In First Embodiment, the tandem backlight is described. Meanwhile, in the present embodiment, a tiling backlight in which a plurality of light guides are arranged in a single plane without overlapping one another is described.

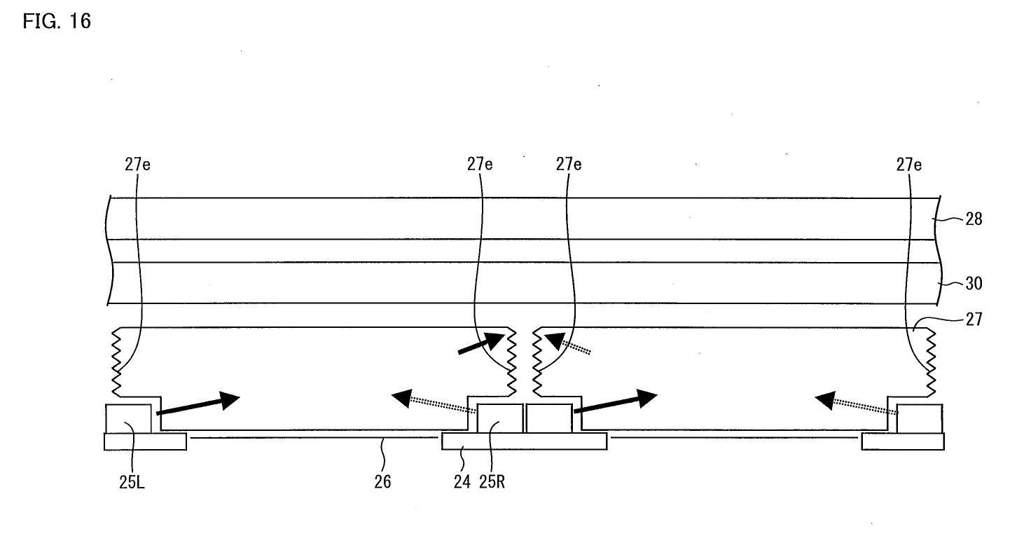

FIG. 15 is a cross-sectional view schematically showing a configuration of a liquid crystal display device 21 in accordance with the present embodiment. FIG. 16 is an enlarged cross-sectional view of a part of the liquid crystal display device 21. The liquid crystal display device 21 includes a backlight 22 (illumination device) and a liquid crystal display panel 23 that is provided so as to face the backlight 22. The liquid crystal display panel 23 has an arrangement identical to that of the liquid crystal display panel 3 of First Embodiment.

The following describes an arrangement of the backlight 22 included in the liquid crystal display device 21.

The backlight 22 is arranged in a backside of the liquid crystal display panel 23 (on a surface of the liquid crystal display panel 23 opposite to a display surface of the liquid crystal display panel 23). As shown in FIG. 15, the backlight 22 includes a substrate 24, a light source 25, a reflecting sheet 26, a light guide 27, a diffuser 28, an optical sheet 29 and a transparent plate 30.

The light source 25 is, for example, a point-like light source such as a light emitting diode (LED) that employs side light emitting. The following describes the LED as an example of the light source 25. The LED employing side light emitting in which R, G and B chips are molded into one package is used as the light source 25. This makes it possible to attain an illumination device having a broad color reproduction scope. The light source 25 is arranged on the substrate 24.

The light guide 27 allows light emitted from the light source 25 to be emitted from a light emitting surface 27a. The light emitting surface 27a is a surface from which light illuminates an object to be illuminated.

Other components of the backlight 22 are substantially identical to those of the backlight 2 of First Embodiment. Therefore, descriptions of such components are omitted here.

The backlight 22 of the present embodiment is configured with at least two light guides 27. That is, the backlight 22 is configured such that a plurality of light guide units 32 each including the light guide 27 and the light source 25 in combination are arranged in a single plane.

As shown in FIGS. 15 and 16, the backlight 22 of the present embodiment is configured such that the light guide units 32 are arranged in a single plane so as not to overlap one another. This forms a flush light-emitting surface (a whole light emitting surface of the backlight 22; a light emitting region) made up of the light emitting surfaces 27a of the plurality of light guides 27.

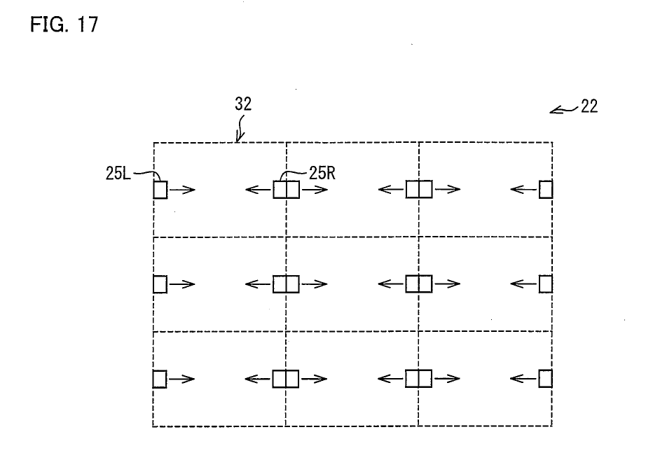

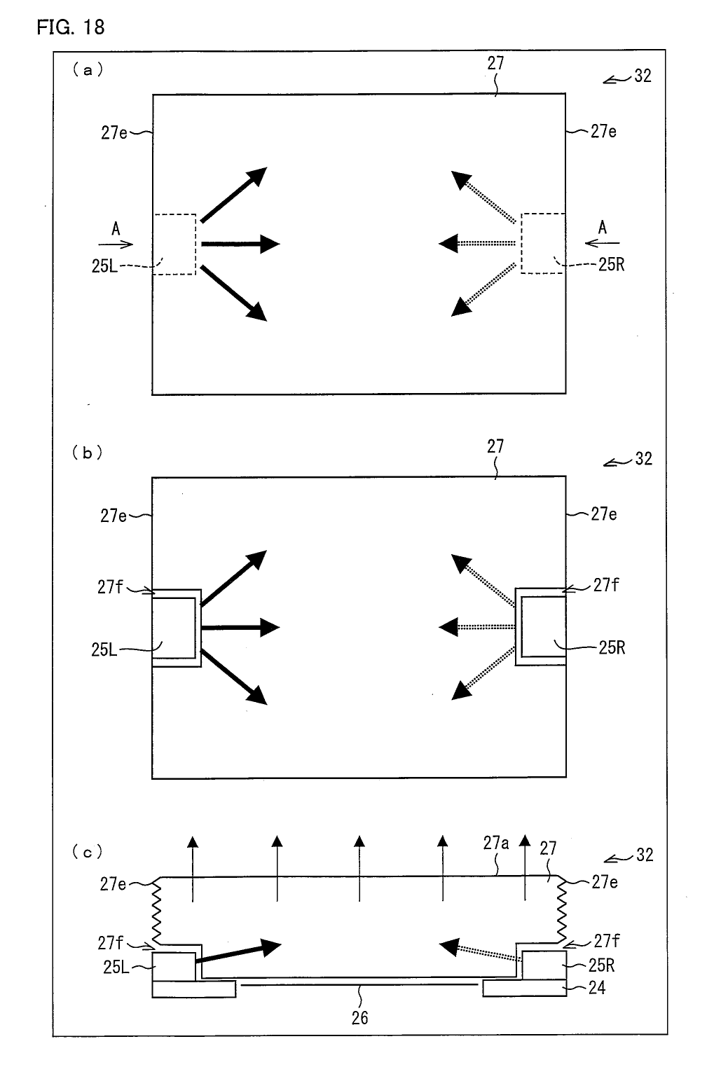

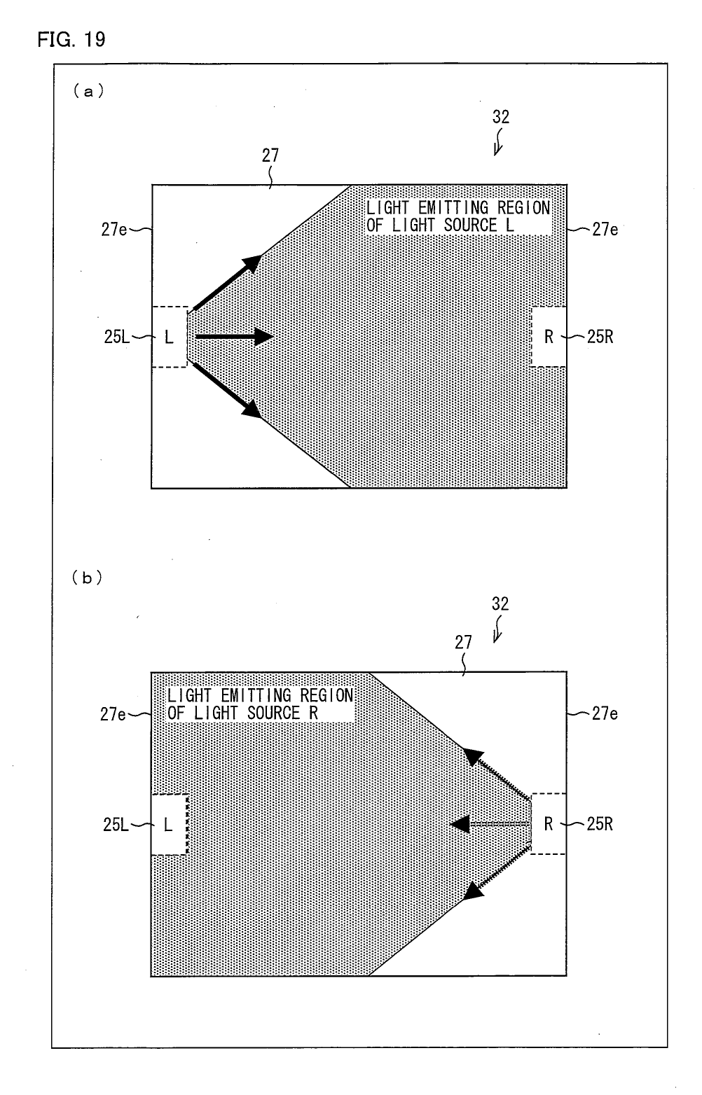

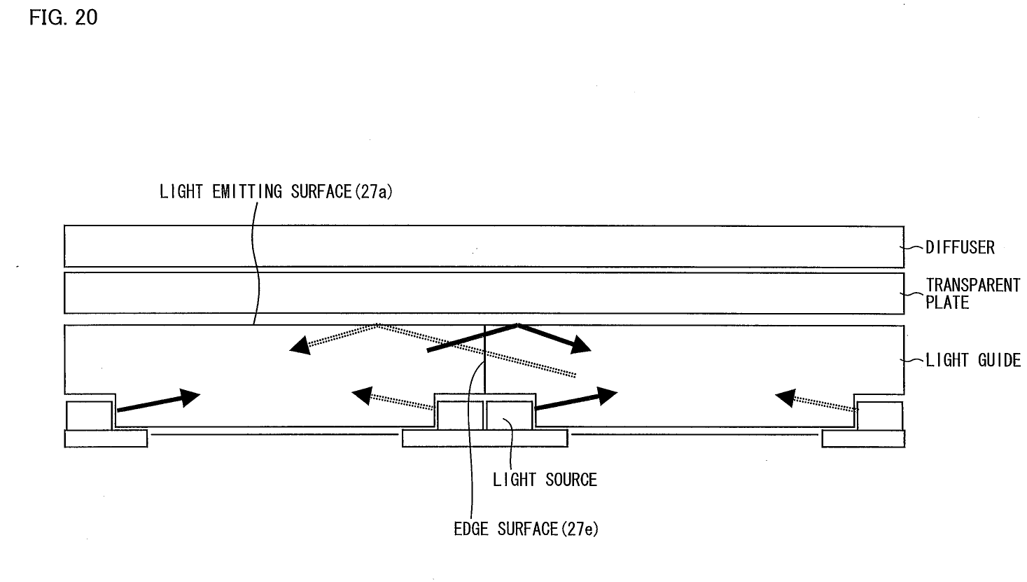

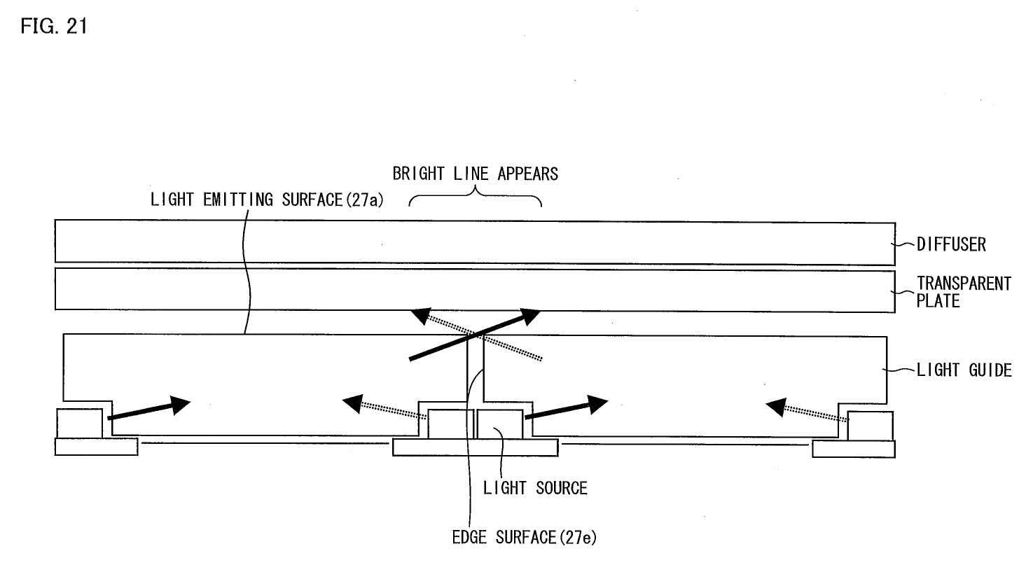

FIG. 17 schematically shows a planar configuration of the backlight 22. As shown in FIG. 17, the backlight 22 is configured such that the plurality of light guide units 32 each including two light sources 25L and 25R (a pair of light sources) are arranged longitudinally and latitudinally. As described above, since the backlight 22 of the present embodiment is configured such that the plurality of light guide units 32 are arranged like tiling, the backlight 22 of the present embodiment is called the tiling backlight.

FIG. 18 shows a configuration of the light guide units 32 included in the backlight 22. (a) of FIG. 18 is a plan view (top view) in a case where the light guide unit 32 is viewed from the liquid crystal display panel 23 (in other words, from an upper surface). (b) of FIG. 18 is a plan view (bottom view) in a case where the light guide unit 32 is viewed from a surface opposite to the upper surface. (c) of FIG. 18 is a cross-sectional view taken along A-A line of the light guide unit 32 shown in (a) of FIG. 18.

The light guide unit 32 shown in FIG. 18 includes the two light sources 25L and 25R and the light guide 27 that allows the light emitted from the light sources to be emitted from the surface of the light guide 27. The light sources 25L and 25R each are incorporated into a hollow concavity 27f that is provided in the light guide 27. The light sources 25L and 25R are arranged so as to face each other. Further, the light sources 25L and 25R are placed on the substrate 24. As shown in FIG. 18, directions (solid arrows and dashed lines) in which the light is emitted from the light sources 25L and 25R are set such that the light emitted from one light source of the light sources 25L and 25R is emitted toward the other light source of the light sources 25L and 25R.

As described above, the point-like two light sources that face each other are arranged in the light guide unit 32 such that the one light source of the two light sources illuminates a region that cannot be illuminated by the other light source of the two light sources and that the other light source of the two light sources illuminates a region that cannot be illuminated by the one light source of the two light sources.

FIG. 19 schematically shows traveling directions of the light emitted from the light sources 24L and 25R that are provided in the light guide unit 32. (a) of FIG. 19 shows a traveling direction of the light emitted from the light source 25L that is provided in the left-hand side of the light guide unit in a case where the light guide unit is viewed from an upper surface of the light guide unit. (b) of FIG. 19 shows a traveling direction of the light emitted from the light source 25R that is provided in the right-hand side of the light guide unit in the case where the light guide unit is viewed from the upper surface of the light guide unit.

As shown in (a) and (b) of FIG. 19, the light sources 25L and 25R are arranged so as to face each other such that the light emitted from the respective light sources enters the light guide 27. This makes it possible to overlap the light emitting regions of the respective light sources each other. It is therefore possible to emit light from the whole light emitting surface 27a of the light guide 27. In the present embodiment, the plurality of above-described light guide units 32 are arranged. It is thus possible to attain a large backlight that causes no dark region.

As shown in FIG. 15, the light emitted from the light source 25 travels in the light guide 27 while continuously diffusing and reflecting, is emitted from the light emitting surface 27a and reaches the liquid crystal display panel 23 through the diffuser 28 and the optical sheet 29.

(Luminance Uniformity)

The following problem occurs not only in the tandem backlight but also in the tiling backlight: a space occurs between the two light guides adjacent each other; the space causes a bright line thereby impairing luminance uniformity. The following describes a principle of luminance nonuniformity.

The light emitted from the light source 25 travels through the light guide 27 via repeating total reflection and then is emitted from the light emitting surface 27a, as described in First Embodiment with reference to FIG. 13. However, as shown in FIG. 12, a part of the light emitted from the light source 25 undergoes no total reflection and directly reaches an edge surface 27e (see FIG. 20) that is distal to the light source 25. Such a part of light is not reduced in its light intensity due to lack of total reflection thereby causing such a part of light to have greater intensity than that of the light emitted from the light emitting surface 27a.

As shown in FIG. 20, if one light guide (left-hand side of FIG. 20) and the other light guide (right-hand side of FIG. 20) that is adjacent to the one light guide are arranged with no space between them, light that leaks out from the edge surface 27e of the one light guide enters the edge surface 27e of the other light guide, travels through the other light guide via repeating total reflection, and is emitted from the light emitting surface 27a. This causes no bright line.

However, in a case where the light guide is actually used, the space occurs between the one light guide and the other light guide that is adjacent to the one light guide, as shown in FIG. 21. This space causes the light emitted from the light source to be directly emitted outward from the edge surface 27e of the light guide. Such emitted light having great intensity appears as a bright line thereby causing luminance unevenness as a whole.

To reduce the light quantity of light emitted from the edge surface 27e of the light guide, the edge surface 27e of the present embodiment has the concaved and/or convexed shape shown in FIGS. 15 and 16 thereon, as with the configuration of the backlight 2 of First Embodiment.

In a case of the tiling backlight of the present embodiment, the light emitted from the two light sources (light sources 25L and 25R) that are arranged so as to face each other is emitted from the edge surfaces 27e that are provided in both sides of the light guide 27 along optical axis directions of the light emitted from the light sources, as described above. The optical axis direction of the emitted light is, in other words, a directivity direction of the emitted light, or a light guide direction of the light that enters the light guide. Hence, the concaved and/or convexed shape is formed on the edge surfaces 27e provided in the both sides of the light guide 27. That is, the concaved and/or convexed shape is formed (i) between the light guides that are adjacent each other along the optical axis direction of the light emitted from the light sources 25 (25L and 25R) and (ii) on the edge surfaces 27e of the light guides 27 adjacent each other. The concaved and/or convexed shape (the concaved and/or convexed shape shown in, for example, FIGS. 6 through 8) described in First Embodiment is applicable to the concaved and/or convexed shape of the present embodiment. Therefore, description for a concrete example of the concaved and/or convexed shape of the present embodiment is omitted here.

As described above, the liquid crystal display device 1 of First Embodiment and the liquid crystal display device 21 of Second Embodiment include the above-described backlights 2 and 22, respectively. This makes it possible to illuminate the liquid crystal display panels 3 and 23 with more uniform light thereby improving a display quality.

The present invention is not limited to the description of the embodiments above, but may be altered by a skilled person within the scope of the claims. An embodiment based on a proper combination of technical means disclosed in different embodiments is encompassed in the technical scope of the present invention.

As described above, the illumination device of the present invention is provided with the light intensity adjusting sections that reduce light transmission quantity, between the light guides adjacent one another along the optical axis directions of the light emitted from the light sources. The light intensity adjusting sections each are the concaved and/or convexed shape formed on at least one of the edge surfaces of the light guides adjacent each other.

According to the arrangement, it is possible to attain the illumination device that has improved its luminance uniformity, with a simpler arrangement.

Further, the liquid crystal display device of the present invention includes the illumination device of the present invention as the backlight. It is therefore possible to attain the liquid crystal display device that has excellent luminance uniformity.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

An illumination device of the present invention is applicable to a backlight of a liquid crystal display device. Particularly, the illumination device of the present invention is suitably applicable to a backlight of a large liquid crystal display device.

### REFERENCE SIGNS LIST

1 and 21: liquid crystal display device
2 and 22: backlight (illumination device)
3 and 23: liquid crystal display panel
4 and 24: substrate
5: light source (LED or cold cathode fluorescent tube)
25 (25L and 25R): light source (LED)
6 and 26: reflecting sheet
7, 17 and 27: light guide
7a and 27a: light emitting surface (of light guide)
7b and 17b: light emitting section
7c: light guide section
7e and 27e: edge surface
8 and 28: diffuser
9 and 29: optical sheet
10 and 30: transparent plate
12 and 32: light guide unit

1. An illumination device, comprising:
a plurality of light sources;
a plurality of light guides, each of which allows light that enters into the light guide from corresponding one or ones of the light sources to be emitted from a surface of the light guide; and
a light intensity adjusting section for reducing light transmission quantity, the light intensity adjusting section being provided between each of the light guides aligned along an optical axis direction of light emitted from the light sources,
the light intensity adjusting section being provided on at least one of face-to-face edge surfaces of the light guides adjacent each other and having a concaved and/or convexed shape.

2. The illumination device as set forth in claim 1, wherein:
the concaved and/or convexed shape is formed by a plurality of convexities, which are arranged in parallel and each of which has two faces that forms a right-angled crest therebetween.

3. The illumination device as set forth in claim 1, wherein:
the concaved and/or convexed shape is formed by a plurality of quadrangle pyramid convexities arranged longitudinally and latitudinally.

4. The illumination device as set forth in claim 2, wherein:
the concaved and/or convexed shape is formed by the plurality of convexities arranged in parallel with a light emitting surface of the at least one of the light guides adjacent each other.

5. The illumination device as set forth in claim 1, wherein:
each of the light guides includes a light emitting section that has the light emitting surface and a light guide section that guides, to the light emitting section, the light entered into the light guide from the at least one of the plurality of light sources,
each of the light guides overlaps with its adjacent one in such a manner that the light emitting section of the light guide overlaps the light guide section of the adjacent one,
the light intensity adjusting section is provided on the at least one of the face-to-face edge surfaces which is an edge surface of a light emitting section of that one of the light guides adjacent each other which is on the other one of the light guides.

6. The illumination device as set forth in claim 1, wherein:
the light guides are arranged so as not to overlap one another,
each of the light guides is associated with at least a pair of light sources among the light sources,
the pair of light sources are arranged so as to face each other, and
the respective face-to-face edge surfaces of the light guides adjacent each other have the concaved and/or convexed shape.

7. A liquid crystal display device, comprising, as a backlight, an illumination device as set forth in claim 1.
